(19) United States
(12) Patent Application Publication
(10) Pub. No.: US 2018/0093459 A1
(43) Pub. Date: Apr. 5, 2018

(54) METHOD OF MANUFACTURING COMPOSITE FILM

(71) Applicant: TEIJIN LIMITED, Osaka-shi, Osaka (JP)

(72) Inventor: Hiroyuki HONMOTO, Osaka-shi (JP)

(73) Assignee: TEIJIN LIMITED, Osaka-shi, Osaka (JP)

(21) Appl. No.: 15/559,535

(22) PCT Filed: Dec. 10, 2015
(86) PCT No.: PCT/JP2015/084720

§ 371 Date: Sep. 19, 2017

(30) Foreign Application Priority Data
Mar. 24, 2015 (JP) 2015-061572

(51) Int. Cl. B32B 27/12; B32B 27/16; B32B 27/20; C09D 7/20; C09D 7/40; B01J 20/28; B05D 3/10

(52) U.S. Cl. CPC B32B 27/12; B32B 27/16; B32B 27/20; C09D 7/20; B05D 2203/00; B01J 20/28054; B05D 3/108; B32B 2305/026; C09D 7/40

(57) ABSTRACT

A method of manufacturing a composite film, the method including:
preparing a coating liquid including a resin and a filler and having a viscosity of from 0.1 Pa·s to 5.0 Pa·s:
removing aggregates contained in the coating liquid by making the coating liquid pass through a filter having a minimum pore diameter that is larger than a maximum particle diameter of the aggregates;
applying the coating liquid that has been subjected to the aggregate removal on one surface or both surfaces of a porous substrate, to form a coating layer; and
solidifying the resin contained in the coating layer, to obtain a composite film including: the porous substrate; and a porous layer that is formed on one surface or both surfaces of the porous substrate and that contains the resin and the filler.

### TECHNICAL FIELD

The present disclosure relates to a method of manufacturing a composite film.

### BACKGROUND ART

Composite films including a porous substrate and a porous layer provided on the porous substrate are conventionally known as battery separators, gas filters, liquid filters, and the like. As a method of manufacturing the composite film described above, a method is known in which a coating liquid containing a resin and a filler is coated on a porous substrate to form a coating layer; and then solidifying the resin contained in the coating layer to form a porous layer (see Patent Document 1, for example). Since the coating liquid for preparing the porous layer on a surface of the porous substrate contains a resin and a filler, there is a case in which aggregates are formed in the liquid, when the time has elapsed after the preparation thereof, for example. When the coating liquid containing the aggregates is coated on the porous substrate, the aggregates may remain in the resulting composite film to cause a decrease in quality of the composite film. Accordingly, techniques are conventionally known for removing the aggregates and foreign substances in the coating liquid by subjecting the coating liquid to filtration before the coating (see Patent Document 1, for example).

### RELATED ART DOCUMENT

### Patent Document

Patent Document 1: JP 5424179 B

### SUMMARY OF INVENTION

### Technical Problem

In terms of production efficiency of a composite film, it is preferable to carry out coating of a coating liquid on a porous substrate having a long length, together with transporting the porous substrate at a high speed. In order to realize the coating in such a manner, a supply rate of the coating liquid needs to be increased. On the other hand, in terms of improving the quality of the composite film, it is preferable to subject the coating liquid to a filtration before the coating. However, when the filtration of the coating liquid is carried out, the supply rate of the coating liquid is reduced.

The embodiment according to the invention has been done in view of the above described problems.

An object of the embodiment according to the invention is to provide a method of manufacturing a composite film, which method is capable of manufacturing a composite film having a high quality at a high production efficiency.

### Solution to Problem

Specific means for solving the object described above include the following embodiments.

[1] A method of manufacturing a composite film, the method comprising: a coating liquid preparation step comprising preparing a coating liquid comprising a resin and a filler and having a viscosity of from 0.1 Pa·s to 5.0 Pa·s:

an aggregate removal step comprising removing aggregates contained in the coating liquid by making the coating liquid pass through a filter having a minimum pore diameter that is larger than a maximum particle diameter of the aggregates;

a coating step comprising coating the coating liquid that has been subjected to the aggregate removal on one surface or both surfaces of a porous substrate, to form a coating layer; and

a solidification step comprising solidifying the resin contained in the coating layer, to obtain a composite film comprising: the porous substrate; and a porous layer that is formed on one surface or both surfaces of the porous substrate and that contains the resin and the filler.

[2] The method of manufacturing a composite film according to claim 1, wherein the minimum pore diameter of the filter is from 2 times to 10 times the maximum particle diameter of the aggregates.

[3] The method of manufacturing a composite film according to [1] or [2], wherein the maximum particle diameter of the aggregates is from 2 μm to 30 μm.

[4] The method of manufacturing a composite film according to any one of [1] to [3], wherein primary particles of the filler have a volume average particle diameter of from 0.1 μm to 3.0 μm.

[5] The method of manufacturing a composite film according to any one of [1] to [4], wherein the minimum pore diameter of the filter is from 30 μm to 70 μm.

[6] The method of manufacturing a composite film according to any one of [1] to [5], wherein the aggregate removal comprises applying a pressure of from 0.05 MPa to 0.5 MPa to the coating liquid, to make the coating liquid pass through the filter.

[7] The method of manufacturing a composite film according to any one of [1] to [6], wherein, in the aggregate removal, the coating liquid is passed through the filter at a flow rate of 0.5 L/min or more.

### Effect of Invention

According to an embodiment of the present invention, a method of manufacturing a composite film, which method is capable of manufacturing a composite film having a high quality at a high production efficiency can be provided.

### BRIEF DESCRIPTION OF DRAWINGS

FIG. 1 is a conceptual diagram showing one embodiment of the manufacturing method of the present disclosure.

FIG. 2 is a conceptual diagram showing another embodiment of the manufacturing method of the present disclosure.

### DESCRIPTION OF EMBODIMENTS

The value range shown using the expression “from . . . to . . . ” in this specification is a range including values described before and after the term “to” as a minimum value and a maximum value, respectively.

In this specification, the term “step” refers not only to an independent step, but also to a step that cannot be clearly distinguished from other steps as long as an expected action of the step is achieved.

In this specification, the “machine direction” means a long direction of a long separator, and the “transverse direction” means a direction orthogonal to the longitudinal direction of the separator. The “machine direction” is also referred to as a “MD direction”, and the “transverse direction” is also referred to as a “TD direction”.

Hereinafter, an embodiment of the invention will be described. The descriptions and examples are intended to illustrate the invention, and are not intended to limit the scope of the invention.

<Method of Manufacturing Composite Film>

The method of manufacturing a composite film according to the present disclosure is a method of manufacturing a composite film including: a porous substrate; and a porous layer formed on one surface or both surfaces of the porous substrate, and containing a resin and a filler. The manufacturing method according to the present disclosure is a method in which a coating liquid containing a resin and a filler is coated on one surface or both surfaces of a porous substrate, to form a porous layer on one surface or both surfaces of the porous substrate. The manufacturing method according to the present disclosure includes the following steps.
Coating liquid preparation step: a step of preparing a coating liquid containing a resin and a filler.
Aggregate removal step: a step of removing aggregates contained in the coating liquid by making the coating liquid pass through a filter.
Coating step: a step of coating the coating liquid that has been subjected to the aggregate removal on one surface or both surfaces of a porous substrate, to form a coating layer.
Solidification step: a step of solidifying the resin contained in the coating layer, to obtain a composite film including: the porous substrate; and a porous layer formed on one surface or both surfaces of the porous substrate and that contains the resin and the filler.

The manufacturing method according to the present disclosure may further include: a water washing step of washing the composite film with water, after the solidification step; and a drying step of removing water from the composite film, after the water washing step.

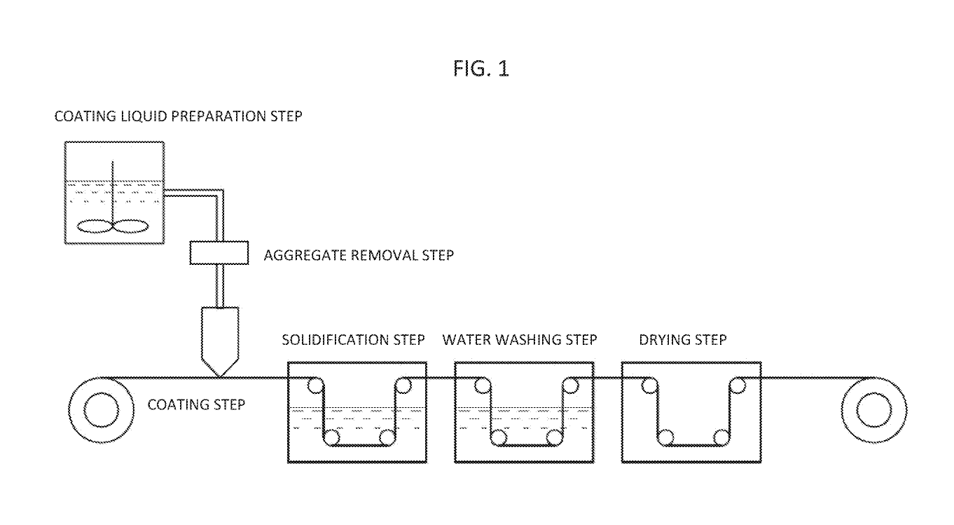

FIG. 1 is a schematic diagram showing one embodiment of the manufacturing method according to the present disclosure. In FIG. 1, a roll of the porous substrate to be used in the production of the composite film is shown on the left side in the figure, and a roll around which the resulting composite film is wound is shown on the right side in the figure. The embodiment shown in FIG. 1 includes the coating liquid preparation step, the aggregate removal step, the coating step, solidification step, the water washing step, and the drying step. In this embodiment, the solidification step is carried out by a wet process. In the present embodiment, the coating step, the solidification step, the water washing step, and the drying step are carried out continuously and sequentially. Further, in the present embodiment, the coating liquid preparation step and the aggregate removal step are carried out at time points suitable for carrying out the coating step. Details regarding the respective steps will be described later.

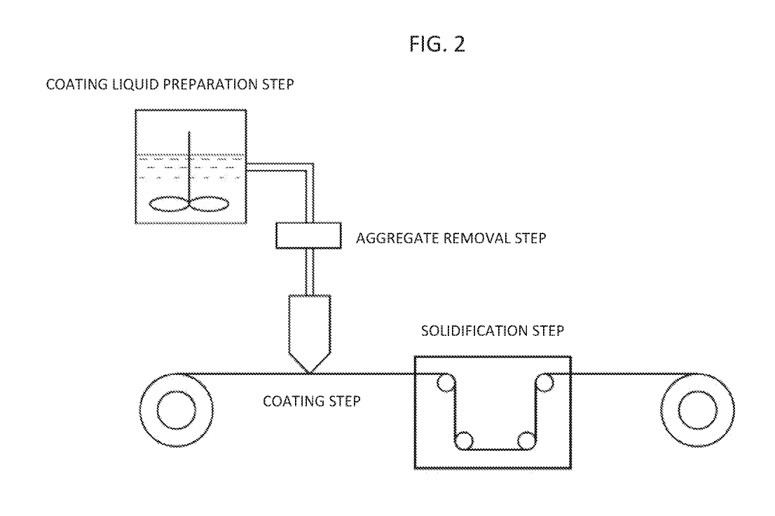

FIG. 2 is a schematic diagram showing another embodiment of the manufacturing method according to the present disclosure. In FIG. 2, a roll of the porous substrate to be used in the production of the composite film is shown on the left side in the figure, and a roll around which the resulting composite film is wound is shown on the right side in the figure. The embodiment shown in FIG. 2 includes the coating liquid preparation step, the aggregate removal step, the coating step, and the solidification step. In this embodiment, the solidification step is carried out by a dry process. In the present embodiment, the coating step and the solidification step are carried out continuously and sequentially. Further, in the present embodiment, the coating liquid preparation step and the aggregate removal step are carried out at time points suitable for carrying out the coating step. Details regarding the respective steps will be described later.

In the manufacturing method according to the present disclosure, a filter to be used in the aggregate removal step is a filter having a minimum pore diameter which is larger than a maximum particle diameter of aggregates contained in the coating liquid is used. When a filter having a minimum pore diameter which is the same as or smaller than the maximum particle diameter of the aggregates is used, the filter hardly allows the coating liquid to pass therethrough, or it takes time for the coating liquid to pass therethrough. When a filter having a minimum pore diameter which is larger than the maximum particle diameter of the aggregates is used, on the other hand, it is possible to remove at least some of the aggregates and to reduce the amount of the aggregates contained in the coating liquid, while allowing the coating liquid to pass therethrough smoothly. Accordingly, the manufacturing method according to the present disclosure serves to improve the production efficiency since the coating liquid can be stably supplied to the coating step, and at the same time, enables to manufacture a composite film having a high quality since a coating liquid containing a smaller amount of aggregates is used in the coating step.

The maximum particle diameter of aggregates contained in a coating liquid herein means the size of aggregates measured in accordance with JIS K5600-2-5: 1999, using a particle size gauge. Specifically, a coating liquid is dropped on the deepest portion of the particle size gauge, and the coating liquid is then swept at a constant speed and pressure, so as to scrape off the coating liquid with a scraper toward the depth of 0 Gm. Then a scale, in the deepest portion of an area at which a particle-like or a linear singular pattern(s) appears (namely, a maximum value of the region where the singular pattern(s) is/are present) is read.

The minimum pore diameter (μm) of the filter is a value which is measured according to a mercury penetration method, using a palm porometer.

In the manufacturing method according to the present disclosure, the coating liquid to be prepared in the coating liquid preparation step has a viscosity of 0.1 Pa·s or more in terms of coating suitability to the porous substrate, and 5.0 Pa·s or less in terms of stably supplying the coating liquid to the coating step. The viscosity (Pa·s) of the coating liquid as used herein is a viscosity obtained by measuring a sample having a temperature of 20° C. using a type B rotational viscometer.

The respective steps in the manufacturing method according to the present disclosure will now be described in detail.

[Coating Liquid Preparation Step]

The coating liquid preparation step is a step for preparing a coating liquid containing a resin and a filler. The coating liquid is prepared, for example, by dissolving a resin in a solvent, or alternatively, by dissolving a resin in a solvent, followed by further dispersing a filler in the resultant.

The details regarding the resin and the filler used in the preparation of the coating liquid, namely, the resin and the filler contained in the porous layer, will be described in the section of “Porous Layer” to be described later.

Examples of the solvent to be used for dissolving the resin in the preparation of the coating liquid (hereinafter, also referred to as “good solvent”) include a polar amide solvent such as N-methylpyrrolidone, dimethylacetamide, dimethylformamide, and dimethylformamide. In terms of forming a porous layer having a favorable porous structure, it is preferable to add and mix a phase separating agent for inducing phase separation, in addition to the good solvent. Examples of the phase separating agent include water, methanol, ethanol, propyl alcohol, butyl alcohol, butanediol, ethylene glycol, propylene glycol, and tripropylene glycol. It is preferable that the phase separating agent is added and mixed with the good solvent to the extent that the resulting coating liquid has a viscosity suitable for the coating.

The solvent to be used in the preparation of the coating liquid is preferably a mixed solvent containing 50% by mass or more, and preferably 60% by mass or more, of the good solvent, and from 10% by mass to 50% by mass, and preferably from 10% by mass to 40% by mass, of the phase separating agent, in terms of forming a favorable porous structure. It is preferable that the coating liquid contains a resin in a concentration of from 3% by mass to 10% by mass, and contains a filler in a concentration of from 10% by mass to 90% by mass, in terms of forming a favorable porous structure.

In the preparation of the coating liquid, a homogenizer, a glass bead mill, a ceramic bead mill, or the like can be used, in order to improve solubility and dispersibility of the resin and the filler in the solvent. Further, in order to improve dispersion efficiency, the resin or the filler may be predispersed in a dispersant, before mixing the resin or the filler with the solvent.

In the coating liquid preparation step, a coating liquid having a viscosity of from 0.1 Pa's to 5.0 Pa's is prepared. The viscosity of the coating liquid is 0.1 Pa's or more, more preferably 0.5 Pa·s or more, and still more preferably 1.0 Pa·s or more, in terms of the coating suitability to the porous substrate. At the same time, the viscosity of the coating liquid is 5.0 Pa's or less, more preferably 4.0 Pa's or less, and still more preferably 3.0 Pa's or less, in terms of stably supplying the coating liquid to the coating step. The viscosity of the coating liquid can be controlled by adjusting a mixing ratio of the solvent, the resin, and the filler.

Aggregates of various sizes containing at least one of the resin or the filler are formed in the coating liquid when, for example, the time has elapsed after the preparation of the coating liquid, or when a liquid temperature thereof is increased. A maximum particle diameter of the aggregates contained in the coating liquid is, for example, from 2 μm to 30 μm.

[Aggregate Removal Step]

The aggregate removal step is a step of removing aggregates contained in the coating liquid, in which a filter having a minimum pore diameter which is larger than a maximum particle diameter of the aggregates contained in the coating liquid is used.

The minimum pore diameter of the filter to be used in the aggregate removal step is preferably 2 times or more, more preferably 3 times or more, and still more preferably 4 times or more the maximum particle diameter of the aggregates contained in the coating liquid, in terms of processing efficiency. The minimum pore diameter of the filter is preferably 10 times or less, more preferably 9 times or less, and still more preferably 8 times or less the maximum particle diameter of the aggregates, in terms of removal efficiency.

The minimum pore diameter of the filter to be used in the aggregate removal step is preferably 10 μm or more, and more preferably 30 μm or more; and it is preferably 100 μm or less, and more preferably 70 μm or less. The minimum pore diameter of the filter to be used in the aggregate removal step is preferably adjusted depending on the maximum particle diameter of the aggregates contained in coating liquid.

Examples of a medium of the filter include a nonwoven fabric, a microporous film, a net-like structure, and a porous body. The filter medium may be a monolayer medium or a multilayered medium. Examples of a material of the filter medium include: an organic material such as a resin (such as polypropylene, polyester, fluororesin, and nylon) or cellulose; and an inorganic material such as a metal, a glass, and a ceramic.

The filter medium may be, for example, a nonwoven fabric of a resin fiber, a cellulose filter paper, a glass fiber filter paper, a metal mesh, or a porous ceramic. A nonwoven fabric of a resin fiber is preferable in terms of its high efficiency in removal of an aggregate contained in the coating liquid. The filter medium has a thickness in the direction of liquid passage of, for example, from 5 mm to 40 mm.

One embodiment of the filter is a filter which includes a filter medium having a continuous density gradient (namely, the gradient of the pore diameter). In the present embodiment, the minimum pore diameter (μm) of the filter refers to a value obtained by measuring the entire filter medium having a continuous density gradient, using a palm porometer based on a mercury penetration method.

One embodiment of the filter is a filter which includes a plurality of types of filter media having different densities and made of the same or different materials, which media having a non-continuous density gradient (namely, the gradient of the pore diameter). In the present embodiment, the minimum pore diameter (μm) of the filter refers to the smallest value of the values obtained by measuring the respective filter media using a palm porometer based on a mercury penetration method.

The filter to be used in the aggregate removal step is preferably: a filter which includes a filter medium having a continuous density gradient (namely, the gradient of the pore diameter); or a filter which includes a plurality of types of filter media having different densities and made of the same or different materials, which media having a non-continuous density gradient (namely, the gradient of the pore diameter).

Examples of the filter to be used in the aggregate removal step include HC series, BO SERIES, SLF SERIES, SRL SERIES, and MPX SERIES manufactured by ROKI TECHNO Co., Ltd., all of which include a polypropylene nonwoven fabric as a filter medium. It is preferable to provide one or more than one of these filters in a housing including an inlet and an outlet of the coating liquid, to be used in the aggregate removal step.

The filter to be used in the aggregate removal step has a total filtration area of, for example, from 0.01 m² to 10 m², and preferably from 0.1 m² to 10 m².

The aggregate removal step is preferably a step in which a pressure is applied to the coating liquid to make the coating liquid pass through the filter, in terms of processing efficiency. The pressure to be applied to the coating liquid is preferably 0.05 MPa or more, more preferably 0.1 MPa or more, and still more preferably 0.2 MPa or more, in terms of processing efficiency. The pressure to be applied to the coating liquid is preferably 0.5 MPa or less, more preferably 0.45 MPa or less, and still more preferably 0.4 MPa or less, in terms of reliably carrying out the removal of the aggregates contained in the coating liquid.

In the aggregate removal step, it is preferable to adjust a flow rate of the coating liquid passing through the filter. The flow rate of the coating liquid passing through the filter is preferably 0.5 L/min or more, more preferably 1 L/min or more, and still more preferably 2 L/min or more, in terms of processing efficiency. The flow rate of the coating liquid passing through the filter is preferably 20 L/min or less, more preferably 15 L/min or less, and still more preferably 10 L/min or less, in terms of reliably carrying out the removal of the aggregates contained in the coating liquid.

A temperature of the coating liquid when passed through the filter is, for example, from 5° C. to 50° C.

[Coating Step]

The coating step is a step of coating the coating liquid containing a resin and a filler on one surface or both surfaces of a porous substrate, to form a coating layer. The coating of the coating liquid on the porous substrate is carried out by a coating means such as a Meyer bar, a die coater, a reverse roll coater, or a gravure coater. A total amount of the coating liquid to be coated on both surfaces is, for example, from 10 mL/m² to 60 mL/m².

One embodiment of the coating step is an embodiment in which the coating liquid is simultaneously coated on both surfaces of the porous substrate, using a first coating means for coating one surface of the porous substrate, and a second coating means for coating the other surface of the porous substrate, which coating means are disposed so as to face each other with the porous substrate interposed therebetween.

One embodiment of the coating step is an embodiment in which the coating liquid is coated on both surfaces of the porous substrate by coating one surface at a time in sequence, using the first coating means for coating one surface of the porous substrate, and the second coating means for coating the other surface of the porous substrate, which coating means are disposed spaced apart from each other in a transport direction of the porous substrate.

A transport speed of the porous substrate in the coating step is preferably 5 m/min or more, and more preferably 10 m/min or more, in terms of the production efficiency. The transport speed of the porous substrate in the coating step is preferably 100 m/min or less, and more preferably 90 m/min or less, in terms of reliably carrying out the coating of the coating liquid.

[Solidification Step]

The solidification step may be carried out by either: a wet process in which the coating layer is brought into contact with a solidifying liquid to solidify the resin contained in the coating layer, thereby obtaining the porous layer: or a dry process in which the solvent contained in the coating layer is removed to solidify the resin contained in the coating layer, thereby obtaining the porous layer. The porous layer formed by the dry process tends to be denser as compared to that formed by the wet process. Accordingly, the wet process is preferable in terms of obtaining a favorable porous structure.

In the wet process, the porous substrate having the coating layer is preferably immersed in a solidifying liquid. Specifically, the porous substrate is preferably passed through a tank (solidification tank) containing a solidifying liquid.

The solidifying liquid to be used in the wet process is generally prepared from the good solvent and the phase separating agent used in the preparation of the coating liquid, and water. A mixing ratio of the good solvent and the phase separating agent is preferably the same as the mixing ratio of the mixed solvent used in the preparation of the coating liquid, in terms of production. A content of water in the solidifying liquid is preferably from 40% by mass to 80% by mass with respect to the total amount of the solidifying liquid, in terms of formability of the porous structure and productivity. The temperature of the solidifying liquid may be, for example, from 20° C. to 50° C.

In the dry process, the method of removing the solvent from the composite film is not particularly limited. Examples thereof include: a method in which the composite film is brought into contact with a heat-generating member; and a method in which the composite film is transported into a chamber controlled at a certain temperature and humidity. In a case in which heat is applied to the composite film, the temperature of the heat is, for example, from 50° C. to 80° C.

[Water Washing Step]

The method of manufacturing a composite film according to the present disclosure preferably includes a water washing step of washing the composite film with water after the solidification step, in a case in which the wet process is used as the solidification step. The water washing step is a step which is performed for the purpose of removing solvents (the solvent used in the coating liquid and the solvent used in the solidifying liquid) contained in the composite film. The water washing step is preferably carried out by transporting the composite film through a water bath. The temperature of the water for washing is, for example, from 0° C. to 70° C.

[Drying Step]

The method of manufacturing a composite film according to the present disclosure preferably includes a drying step of removing water from the composite film after the water washing step. The method of drying is not particularly limited. Examples thereof include: a method in which the composite film is brought into contact with a heat-generating member; a method in which the composite film is transported into a chamber controlled at a certain temperature and humidity; and a method in which hot air is applied to the composite film. In a case in which heat is applied to the composite film, the temperature of the heat is, for example, from 50° C. to 80° C.

The manufacturing method according to the present disclosure may employ the following embodiments.
As a part of the coating liquid preparation step, the solvent for preparing the coating liquid is subjected to a treatment in which the solvent is passed through a filter before being mixed with a resin, in order to remove foreign substances therefrom. The filter to be used in this treatment has a retainable particle diameter of, for example, from 0.1 μm to 100 μm.
An agitator is provided in a tank in which the coating liquid preparation step is carried out, and the coating liquid is constantly stirred with the agitator to prevent precipitation of solid components (such as a filler) in the coating liquid.
A piping for transporting the coating liquid from the coating liquid preparation step to the coating step is arranged in a circular system, and the coating liquid is circulated within the piping to prevent aggregation of solid components in the coating liquid. In this case, it is preferable that a temperature of the coating liquid in the piping is controlled to be constant.
A precision metering pump is provided as a pump for supplying the coating liquid from the coating liquid preparation step to the aggregate removal step.
A non-pulsating metering pump is provided as a pump for supplying the coating liquid from the aggregate removal step to the coating step.
A static elimination device is provided upstream of the coating step, for destaticizing the surface of the porous substrate.
A housing is provided around a coating means, to maintain clean the environment in which the coating step is carried out, and to control a temperature and humidity of the atmosphere in the coating step.
A sensor for detecting an amount of the coating liquid coated is provided downstream of the coating means, to correct the coated amount in the coating step.

The porous substrate and the porous layer included in the composite film will now be described in detail.

[Porous Substrate]

The porous substrate refers to a substrate which includes pores or cavities in the interior thereof. Examples of such a substrate include: a microporous film; a porous sheet composed of a fibrous product such as a nonwoven fabric or a paper; and a composite porous sheet obtained by layering one or more other porous layers on the microporous film or the porous sheet as described above. In the present disclosure, a microporous film is preferred, in terms of obtaining a thinner and stronger composite film. The microporous film refers to a film which includes a number of micropores in the interior thereof, and has a structure in which these micropores are connected, so that a gas or a liquid is able to pass therethrough from one surface to the other surface of the film.

A material as a component of the porous substrate is preferably a material having an electrical insulating property, and may be either an organic material or an inorganic material.

The material as a component of the porous substrate is preferably a thermoplastic resin, in terms of imparting a shutdown function to the porous substrate. The shutdown function refers to a function, in a case in which the composite film is used as a battery separator, in which the component material is melted to clog the pores of the porous substrate, when the temperature of the battery is increased, thereby blocking ion migration and preventing a thermal run away of the battery. The thermoplastic resin is suitably a thermoplastic resin having a melting temperature of less than 200° C., and particularly preferably a polyolefin.

The porous substrate is preferably a microporous film containing a polyolefin (hereinafter, also referred to as “polyolefin microporous film). Examples of the polyolefin microporous film include polyolefin microporous films used in conventional battery separators. Among these, one having favorable mechanical properties and substance permeability can be preferably selected.

The polyolefin microporous film preferably contains one or both of polyethylene in terms of exhibiting the shutdown function. A content of polyethylene in the polyolefin microporous film is preferably 95% by mass or more with respect to a total mass of the polyolefin microporous film.

The polyolefin microporous film is preferably a polyolefin microporous film containing polyethylene and polypropylene, since such a film has a heat resistance sufficient for preventing the film from easily rupturing when exposed to a high temperature. Examples of the polyolefin microporous film as described above include a microporous film in which polyethylene and polypropylene coexist within one layer. The microporous film as described above preferably contains 95% by mass or more of polyethylene and 5% by mass or less of polypropylene, in terms of obtaining both the shutdown function and the heat resistance in a balanced manner. Further, in terms of obtaining both the shutdown function and the heat resistance in a balanced manner, the microporous film is preferably a polyolefin microporous film having a laminated structure composed of two or more layers, in which at least one layer contains polyethylene and at least one layer contains polypropylene.

The polyolefin included in the polyolefin microporous film suitably has a weight-average molecular weight of from 100,000 to 5,000.000. When the polyolefin has a weight-average molecular weight of greater than 100,000, sufficient mechanical properties can be imparted to the microporous film. When the polyolefin has a weight-average molecular weight of less than 5,000,000, the microporous film has a favorable shut down property, and the film formation of the microporous film can be carried out easily.

Examples of manufacturing the polyolefin microporous film include: a method in which a melted polyolefin resin is extruded from a T-die to be formed into a sheet. The resultant is subjected to a crystallization treatment, followed by stretching, and then further subjected to a heat treatment, thereby obtaining a microporous film; and a method in which a polyolefin resin melted along with a plasticizer, such as liquid paraffin, is extruded from a T-die, the resultant is cooled to be formed into a sheet, stretching the resulting sheet, the plasticizer is extracted therefrom, and the resultant is subjected to a heat treatment, thereby obtaining a microporous film.

Examples of the porous sheet composed of a fibrous product include porous sheets, such as nonwoven fabrics and papers, composed of fibrous products such as: polyesters such as polyethylene terephthalate; polyolefins such as polyethylene and polypropylene: heat resistant resins such as aromatic polyamides, polyimides, polyethersulfones, polysulfones, polyether ketones, and polyetherimides; and celluloses. The heat resistant resin refers to a resin having a melting temperature of 200° C. or higher, or a resin which does not have a melting temperature and has a decomposition temperature of 200° C. or higher.

Examples of the composite porous sheet include one that has a structure in which a functional layer(s) is/are layered on a porous sheet composed of a microporous film or a fibrous product. Such a composite porous sheet is preferred, because the functional layer(s) included therein allow(s) for imparting an additional function(s). In terms of imparting heat resistance, for example, a porous layer composed of a heat resistant resin, or a porous layer composed of a heat resistant resin and an inorganic filler can be used as the functional layer. The heat resistant resin may be, for example, one kind or two or more kinds of heat resistant resins selected from aromatic polyamides, polyimides, polyethersulfones, polysulfones, polyether ketones or polyetherimides. Examples of the inorganic filler include a metal oxide such as an alumina and a metal hydroxide such as magnesium hydroxide. The composite porous sheet having the above structure may be formed, for example, by: a method in which a functional layer is coated on a microporous film or a porous sheet; a method in which a microporous film or a porous sheet and a functional layer are bonded with an adhesive agent; and a method in which a microporous film or a porous sheet and a functional layer are bonded by thermocompression bonding.

The porous substrate preferably has a width of from 0.1 m to 3.0 m, in terms of compatibility with the manufacturing method according to the present disclosure.

The porous substrate preferably has a thickness of from 5 μm to 50 μm.

The porous substrate preferably has an elongation at break in the MD direction of 10% or more, and more preferably 20% or more, and has an elongation at break in the TD direction of 5% or more, and more preferably 10% or more, in terms of mechanical strength. The elongation at break of the porous substrate is obtained by carrying out a tensile test in an atmosphere at a temperature of 20° C. using a tensile tester, at a tensile speed of 100 mm/min.

The porous substrate preferably has a Gurley value (JIS P8117 (2009)) of 50 sec/100 cc to 800 sec/100 cc, in terms of the mechanical strength and the substance permeability.

The porous substrate preferably has a porosity of 20% to 60%, in terms of the mechanical strength, handling property, and the substance permeability.

The porous substrate preferably has an average pore diameter of from 20 nm to 100 nm, in terms of the substance permeability. The average pore diameter as used herein refers to a value measured using a palm porometer, in accordance with ASTM E1294-89.

[Porous Layer]

The porous layer refers to a layer which includes a number of micropores in the interior thereof, and has a structure in which these micropores are connected, so that a gas or a liquid is able to pass therethrough from one surface to the other surface of the film.

In a case in which the composite film is used as a battery separator, the porous layer is preferably an adhesive porous layer capable of adhering to an electrode. It is more preferable that the adhesive porous layer is provided on both surfaces of the porous substrate, rather than being provided on only one surface of the porous substrate.

The porous layer is formed by coating: a coating liquid containing a resin and a filler. Accordingly, the porous layer contains a resin and a filler. The filler may be either an inorganic filler or an organic filler. The filler is preferably inorganic particles, in terms of porosifying the porous layer and of heat resistance. A description will now be given below regarding the porous layer, and the components, such as a resin, contained in the coating liquid and the porous layer.

(Resin)

A type of the resin to be contained in the porous layer is not limited. The resin to be contained in the porous layer is preferably a resin (so-called binder resin) having a function to bind particles of a filler. In a case in which the composite film is prepared by the wet process, the resin to be contained in the porous layer is preferably a hydrophobic resin, in terms of production compatibility. In a case in which the composite film is used as a battery separator, the resin to be contained in the porous layer is preferably a resin which is stable in an electrolyte solution, which is electrochemically stable, which has a function of binding inorganic particles, and which is capable of adhering to an electrode. The porous layer may contain one kind of resin, or two or more kinds of resins.

Examples of the resin to be contained in the porous layer is preferably polyvinylidene fluoride, a polyvinylidene fluoride copolymer, a styrene-butadiene copolymer, a homopolymer or a copolymer of a vinyl nitrile such as acrylonitrile or methacrylonitrile, or a polyether such as polyethylene oxide or polypropylene oxide. Of these, polyvinylidene fluoride and a polyvinylidene fluoride copolymer, referred to as a polyvinylidene fluoride resin, are preferred.

Examples of the polyvinylidene fluoride resin include a homopolymer of vinylidene fluoride (namely, polyvinylidene fluoride), a copolymer of vinylidene fluoride and another monomer copolymerizable with vinylidene fluoride (namely, a polyvinylidene fluoride copolymer), and any mixture of these resins. Examples of the monomer copolymerizable with vinylidene fluoride include tetrafluoroethylene, hexafluoropropylene, trifluoroethylene, trichloroethylene, and vinyl fluoride. One kind or two or more kinds of these monomers can be used. The polyvinylidene fluoride resin can be obtained by emulsion polymerization or suspension polymerization.

The resin to be contained in the porous layer is preferably a heat resistant resin (a resin having a melting temperature of 200° C. or higher, or a resin which does not have a melting temperature and has a decomposition temperature of 200° C. or higher), in terms of heat resistance. Examples of the heat resistant resin include polyamides (nylons), wholly aromatic polyamides (aramids), polyimides, polyamideimides, polysulfones, polyketones, polyether ketones, polyether sulfones, polyetherimides, celluloses, and any mixture of these resins. Among these, a wholly aromatic polyamide is preferred, in terms of ease of forming a porous structure, ability to bind to inorganic particles, and oxidation resistance. Among the wholly aromatic polyamides, a meta-type wholly aromatic polyamide is preferred, and polymetaphenylene isophthalamide is particularly preferred, in terms of ease of shaping.

Examples of the resin to be contained in the porous layer include a particulate resin or a water soluble resin. Examples of the particulate resin include particles containing a resin such as a polyvinylidene fluoride resin, a fluorine rubber, or a styrene-butadiene rubber. The particulate resin can be used by dispersing the particulate resin in a dispersion medium such as water, thereby preparing the coating liquid. Examples of the water soluble resin include a cellulose resin and a polyvinyl alcohol. The water soluble resin can be used by, for example, dissolving the water soluble resin to water, thereby preparing the coating liquid. The particulate resin and the water soluble resin are suitable in a case in which the solidification step is carried out by the dry process.

(Filler)

A type of the filler to be contained in the porous layer is not limited. The filler to be contained in the porous layer may be either an inorganic filler or an organic filler. The filler is preferably particles in which primary particles preferably have a volume average particle diameter of from 0.01 μm to 10 μm, which is more preferably from 0.1 μm to 10 μm and further preferably from 0.1 μm to 3.0 μm.

The filler is preferably inorganic particles, in terms of porosifying the porous layer and of heat resistance. The inorganic particle to be contained in the porous layer is preferably particles which are stable in an electrolyte solution, and at the same time, electrochemically stable. The porous layer may contain one kind of inorganic particles, or two or more kinds thereof.

Examples of the inorganic particles to be contained in the porous layer include: metal hydroxides such as aluminum hydroxide, magnesium hydroxide, calcium hydroxide, chromium hydroxide, zirconium hydroxide, cerium hydroxide, nickel hydroxide, and boron hydroxide: metal oxides such as silica, alumina, zirconia, and magnesium oxide; carbonates such as calcium carbonate and magnesium carbonate; sulfates such as barium sulfate and calcium sulfate; and clay minerals such as calcium silicate and talc. Among these, a metal hydroxide and a metal oxide are preferred, in terms of imparting flame retardancy or of a destaticizing effect. The inorganic particles may be particles which have been surface modified by a silane coupling agent or the like.

The inorganic particles may have an arbitrary shape, and may be in the shape of any of spheres, ellipsoids, plates, and needles, or may be amorphous. It is preferable that the primary particles of the inorganic particles have a volume average particle diameter of from 0.01 μm to 10 μm, more preferably from 0.1 μm to 10 μm, and still more preferably from 0.1 μm to 3.0 μm, in terms of shaping property of the porous layer, the substance permeability of the composite film, and the slippage of the composite film.

In a case in which the porous layer contains inorganic particles, a ratio of the inorganic particles with respect to a total amount of the resin and the inorganic particles is, for example, from 30% by volume to 90% by volume.

The porous layer may contain an organic filler as a filler. Examples of the organic filler include: particles composed of crosslinked polymers such as crosslinked poly(meth)acrylic acids, crosslinked poly(meth) acid esters, crosslinked polysilicones, crosslinked polystyrenes, crosslinked polydivinylbenzenes, crosslinked products of styrene-divinylbenzene copolymers, polyimides, melamine resins, phenol resins, and benzoguanamine-formaldehyde condensation products; and particles composed of heat resistant resins such as polysulfones, polyacrylonitriles, aramids, polyacetals, and thermoplastic polyimides.

The porous layer preferably has a thickness, on one surface of the porous substrate, of from 0.5 μm to 5 μm, in terms of the mechanical strength.

The porous layer preferably has a porosity of from 30% to 80%, in terms of the mechanical strength, the handling property, and the substance permeability.

The porous layer preferably has a pore diameter of from 20 nm to 100 nm, in terms of the substance permeability. An average pore diameter of the porous layer herein refers to a value measured using a palm porometer, in accordance with ASTM E1294-89.

[Property of Composite Film]

A thickness of the composite film may be, for example, from 5 pun to 100 μm. When used as a battery separator, the composite film has a thickness of from 5 min to 50 μm, for example.

The composite film preferably has a Gurley value (JIS P8117 (2009)) of from 50 sec/100 cc to 800 sec/100 cc, in terms of the mechanical strength and the substance permeability.

The composite film preferably has a porosity of from 30% to 60%, in terms of the mechanical strength, the handling property, and the substance permeability.

[Porosity]

A porosity of the composite film is determined by the following equation. A porosity of the porous substrate and a porosity of the porous layer are also determined in the same manner.

Porosity (%)={1−(Wa/da+Wb/db+Wc/dc+ . . . +Wn/dn)/t}×100

In the equation, Wa, Wb, Wc, . . . , Wn are the weights (g/cm²) of constituent materials to a, b, c, . . . , n respectively; da, db, dc, . . . , dn are the true densities (g/cm³) of the constituent materials a, b, c, . . . , n respectively; and t is the film thickness (cm) of a layer of interest.

[Applications of Composite Film]

The composite film can be used, for example, as a battery separator, a film for a capacitor, a gas filter, a liquid filter, or the like. In particular, the composite film in the present disclosure is particularly suitably used as a nonaqueous secondary battery separator.

### EXAMPLES

Hereinafter, the present invention is described in further detail with reference to Examples. The material, amount of use, proportion, procedure, or the like described below can be appropriately modified without deviating from the spirit of the present invention. Therefore, the scope of the present invention should not be construed to be limited by the following specific examples.

<Method for Measurement of Physical Property>

The following measurement methods were applied in Examples and Comparative Examples.

[Primary Particle Diameter of Filler]

A volume average particle diameter (μm) of primary particles of a filler was measured using a ZETASIZER NANO ZSP, manufactured by Spectris Co., Ltd.

[Viscosity of Coating Liquid]

A viscosity (Pa·s) of a coating liquid was measured using a Type B rotational viscometer (product number: RVDV+1, spindle: SC4-18, manufactured by Brookfield Company). A sample was obtained from a coating liquid which had been homogenized by stirring, and measurement was performed under the conditions of: sample amount: 7 mL; sample temperature: temperature: 20° C.; and number of revolution of the spindle: 10 revolutions/min.

[Maximum Particle Diameter of Aggregates]

A maximum particle diameter (μm) of aggregates contained in a coating liquid was measured by a particle size gauge (maximum depth: 25 μm; scale interval: 5 μm, measurement range: from 0 μm to 25 μm), manufactured by Dai-Ichi Sokuhan Works Co. The measurement was carried out in accordance with JIS K5600-2-5: 1999. Specifically, the coating liquid was dropped on the deepest portion of the particle size gauge, and the coating liquid was then swept at a constant speed and pressure, so as to scrape off the coating liquid with a scraper toward the depth of 0 μm. Then a scale, in the deepest portion of an area at which a particle-like or a linear singular pattern(s) had appeared (namely, a maximum value of the region where the singular pattern(s) was/were present) was read. This measurement was repeated 10 times, and an average of the measured values was calculated to be taken as the maximum particle diameter (μm) of the aggregates. Since there is a case in which aggregates precipitate in the coating liquid over time, the sample to be placed on the particle size gauge was obtained from the coating liquid which had been homogenized by stirring.

[Minimum Pore Diameter of Filter]

A minimum pore diameter (μm) of the filter was measured according to a mercury penetration method, using a palm porometer manufactured by PMI co., ltd. A sample was obtained by collecting a portion of the filter medium from the interior of the filter, with care to maintain the shape of the filter medium.

<Method for Evaluating Quality of Composite Film>

Qualities of composite films produced in Examples and Comparative Examples were evaluated according to the following evaluation methods.

[Number of Foreign Substances on Surface]

A surface of each composite film on the side of the porous layer was observed using a defect inspection system for plain surfaces, manufactured by NIRECO Corporation, and a number of foreign substances (black spots) having a long diameter of 100 μm or more were counted. Then the composite films were classified based on the following standards.

A: The number of foreign substances is less than one per 100 m².

B: The number of foreign substances is one or more but less than 5 per 100 m².

C: The number of foreign substances is 5 or more but less than 10 per 100 m².

D: The number of foreign substances is 10 or more per 100 m².

[Surface Smoothness]

A sample having a size of 8 cm width and 10 m length was cut out from each composite film. A film thickness of each sample was measured, at the center, at a position 1 cm interior from one end, and at a position 1 cm interior from the other end, in the width direction of the sample, each at every 10 cm in the length direction of the sample. Then a mean value and a standard deviation of all the measured values were calculated. The thus obtained standard deviation was divided by the mean value, to obtain a ratio Q (standard deviation/mean value) of the standard deviation of the film thickness to the mean value of the film thickness. Then the composite films were classified based on the following standards.

AA: The ratio Q is 1% or less.

A: The ratio Q is greater than 1% but equal to or less than 2%.

B: The ratio Q is greater than 2% but equal to or less than 3%.

C: The ratio Q is greater than 3%.

<Production of Composite Film>

### Example 1

### —Coating Liquid Preparation—

Polymetaphenylene isophthalamide was dissolved in a mixed solvent (mass ratio 1:1) of dimethylacetamide (DMAc) and tripropylene glycol (TPG), and aluminum hydroxide particles (Al(OH)₃) were further dispersed in the resultant, to prepare a coating liquid. The coating liquid was adjusted to a composition (mass ratio) of Al(OH)₃:polymetaphenylene isophthalamide:DMAc:TPG=16:4:40:40. A viscosity of the coating liquid and a maximum particle diameter of aggregates contained in the coating liquid are shown in Table 1.

—Aggregate Removal Step—

A filter manufactured by Roki Techno Co., Ltd., model number: 62.5L-HC-50AD (filter medium: polypropylene nonwoven fabric, filtration area: 0.02 m²) was used. This filter has a hollow cylindrical shape, and the filter medium inside the filter has a continuous density gradient. The filter is a type of the filter which allows a liquid to flow from the exterior into the interior thereof. This filter was provided at one location within a housing, and 10 L of the coating liquid was made to pass through the filter. The coating liquid was supplied from a tank in which the liquid was prepared to the filter, by a motor-driven precision metering pump (SMOOTHFLOW PUMP, manufactured by Tacmina Corporation), and a pressure applied to the coating liquid and a flow rate of the coating liquid were adjusted. Conditions for the process of the aggregate removal step are shown in Table 1.

—Coating—

A polyethylene microporous film (PE film) having a long length and a width of 1 m as a porous substrate was prepared. Then the coating liquid which had been subjected to the aggregate removal was coated on one surface of the porous substrate, using a die coater, to form a coating layer. A transport speed of the porous substrate in the coating step was set to 10 min.

—Solidification—

The porous substrate on which the coating layer had been formed was transported to a solidification bath, and immersed in a solidifying liquid (water:DMAc:TPG=43:40:17 [mass ratio], liquid temperature: 30° C.) to solidify the resin contained in the coating layer, thereby obtaining a composite film.

—Water Washing Step and Drying Step—

The composite film was transported to a water bath controlled to a temperature of 30° C., and washed with water. The washed composite film was made to pass through a drying apparatus equipped with heating rolls to carry out drying.

The respective steps described above were carried out continuously, to obtain a composite film including a polyethylene microporous film and a porous layer formed on one surface of the polyethylene microporous film. The quality of the thus obtained composite film was evaluated, and the results are shown in Table 1. Data and the evaluation results of composite films obtained in other Examples and Comparative Examples are also shown in Table 1.

### Example 2

A composite film was prepared in the same manner as in Example 1, except that the filter used was changed to a filter manufactured by ROKI TECHNO Co., Ltd., model number: 62.5L-HC-25AD (filter medium: polypropylene nonwoven fabric, filtration area: 0.02 m²).

### Example 3

A composite film was prepared in the same manner as in Example 1, except that the filter used was changed to a filter manufactured by ROKI TECHNO Co., Ltd., model number: 62.5L-HC-100AD (filter medium: polypropylene nonwoven fabric, filtration area: 0.02 m²).

### Comparative Example 1

The filter used was changed to a filter manufactured by ROKI TECHNO Co., Ltd., model number: 62.5 L-HC-10AD (filter medium: polypropylene nonwoven fabric, filtration area: 0.02 m²), and as a result, the filter was clogged, and it was unable to perform the aggregate removal, and thus unable to produce a composite film.

### Comparative Example 2

The filter used was changed to a filter manufactured by ROKI TECHNO Co., Ltd., model number: 62.5 L-HC-05AD (filter medium: polypropylene nonwoven fabric, filtration area: 0.02 m²), and as a result, the filter was clogged, and it was unable to perform the aggregate removal, and thus unable to produce a composite film.

### Example 4

A composite film was prepared in the same manner as in Example 1, except that the coating liquid was changed to one that contains aggregates with a maximum particle diameter of 15 μm.

### Example 5

A composite film was prepared in the same manner as in Example 1, except that the coating liquid was changed to one that contains aggregates with a maximum particle diameter of 20 μm.

### Example 6

A composite film was prepared in the same manner as in Example 1, except that the coating liquid was changed to one that contains aggregates with a maximum particle diameter of 8 μm.

### Examples 7 to 10

Composite films were prepared in the same manner as in Example 1 respectively, except that the condition of the aggregate removal was changed as shown in Table 1.

### Example 11

A composite film was prepared in the same manner as in Example 1, except that in the coating liquid preparation, polymetaphenylene isophthalamide was changed to polyvinylidene fluoride (PVDF), and aluminum hydroxide particles were changed to alumina particles (Al₂O₃).

### Example 12

A composite film was prepared in the same manner as in Example 1, except that polymetaphenylene isophthalamide was changed to polyvinylidene fluoride (PVDF) and aluminum hydroxide particles were changed to magnesium hydroxide particles in the coating liquid preparation, and the condition of the aggregate removal was changed as shown in Table 1.

### Example 13

A composite film was prepared in the same manner as in Example 1, except that polymetaphenylene isophthalamide was changed to polyvinylidene fluoride (PVDF) and aluminum hydroxide particles were changed to cross-linked polymethyl methacrylate (PMMA) particles in the coating liquid preparation, and the condition of the aggregate removal was changed as shown in Table 1.

### Example 14

A composite film was prepared in the same manner as in Example 1, except that polymetaphenylene isophthalamide was changed to a polyvinylidene fluoride (PVDF) emulsion in the coating liquid preparation, the condition of the aggregate removal was changed as shown in Table 1, and the solidification was changed to a dry process in which drying is performed at a temperature of 60° C. (and accordingly, water washing and drying thereafter are omitted).

### Example 15

A composite film was prepared in the same manner as in Example 1, except that the porous substrate was changed to a polyethylene terephthalate nonwoven fabric (PET nonwoven fabric).

### Example 16

A composite film was prepared in the same manner as in Example 1, except that the composition (mass ratio) of the coating liquid was changed to Al(OH)₃:polymetaphenylene isophthalamide:DMAc:TPG=16:4:35:45, the filter used was changed to a filter manufactured by ROKI TECHNO Co., Ltd., model number: 62.5L-HC-100AD (filter medium: polypropylene nonwoven fabric, filtration area: 0.02 m²), and the condition of the aggregate removal was changed as shown in Table 1.

TABLE 1

| | | Coating liquid | | | | |
|---|---|---|---|---|---|---|
| | | | | Primary | Maximum | |
| | | | | particle | particle | |
| | | | | diameter of | diameter of | |
| | Porous | | | filler | aggregates | Viscosity |
| | substrate | Type of resin | Type of filler | μm | μm | Pa · s |
| Comparative | PE film | Aramid | Al(OH)₃ | 0.8 | 10 | 2.2 |
| Example 1 | | | | | | |
| Comparative | PE film | Aramid | Al(OH)₃ | 0.8 | 10 | 2.2 |
| Example 2 | | | | | | |
| Example 1 | PE film | Aramid | Al(OH)₃ | 0.8 | 10 | 2.2 |
| Example 2 | PE film | Aramid | Al(OH)₃ | 0.8 | 10 | 2.2 |
| Example 3 | PE film | Aramid | Al(OH)₃ | 0.8 | 10 | 2.2 |
| Example 4 | PE film | Aramid | Al(OH)₃ | 0.8 | 15 | 2.2 |
| Example 5 | PE film | Aramid | Al(OH)₃ | 0.8 | 20 | 2.2 |
| Example 6 | PE film | Aramid | Al(OH)₃ | 0.8 | 8 | 2.2 |
| Example 7 | PE film | Aramid | Al(OH)₃ | 0.8 | 10 | 2.2 |
| Example 8 | PE film | Aramid | Al(OH)₃ | 0.8 | 10 | 2.2 |
| Example 9 | PE film | Aramid | Al(OH)₃ | 0.8 | 10 | 2.2 |
| Example 10 | PE film | Aramid | Al(OH)₃ | 0.8 | 10 | 2.2 |
| Example 11 | PE film | PVDF | Al₂O₃ | 0.1 | 5 | 2.8 |
| Example 12 | PE film | PVDF | Mg(OH)₂ | 0.8 | 15 | 0.4 |
| Example 13 | PE film | PVDF | PMMA | 1.0 | 20 | 0.5 |
| Example 14 | PE film | PVDF emulsion | Al(OH)₃ | 0.2 | 10 | 1.0 |
| Example 15 | PET nonwoven | Aramid | Al(OH)₃ | 0.8 | 10 | 2.2 |
| | fabric | | | | | |
| Example 16 | PE film | Aramid | Al(OH)₃ | 0.8 | 10 | 4.0 |

| | Aggregate removal step | | | | Composite film | |
|---|---|---|---|---|---|---|
| | Temperature | Minimum pore | | | Number of | |
| | of coating | diameter of | | | foreign | |
| | liquid | filter | Pressure | Flow rate | substances | Surface |
| | ° C. | μm | MPa | L/min | on surface | smoothness |
| Comparative | 20 | 10 | 0.4 | Unable to | Unable to | Unable to |
| Example 1 | | | | process | measure | measure |
| Comparative | 20 | 5 | 0.4 | Unable to | Unable to | Unable to |
| Example 2 | | | | process | measure | measure |
| Example 1 | 20 | 50 | 0.4 | 3 | A | A |
| Example 2 | 20 | 30 | 0.4 | 3 | A | A |
| Example 3 | 20 | 100 | 0.4 | 3 | B | B |
| Example 4 | 20 | 50 | 0.4 | 3 | A | A |
| Example 5 | 20 | 50 | 0.4 | 3 | A | A |
| Example 6 | 20 | 50 | 0.4 | 3 | A | AA |
| Example 7 | 20 | 50 | 0.2 | 3 | A | A |
| Example 8 | 20 | 50 | 0.1 | 3 | A | A |
| Example 9 | 20 | 50 | 0.3 | 5 | A | A |
| Example 10 | 20 | 50 | 0.3 | 2 | A | A |
| Example 11 | 20 | 50 | 0.4 | 3 | A | A |
| Example 12 | 20 | 50 | 0.3 | 5 | A | A |
| Example 13 | 20 | 50 | 0.3 | 3 | A | A |
| Example 14 | 20 | 50 | 0.3 | 3 | A | A |
| Example 15 | 20 | 50 | 0.4 | 3 | A | B |
| Example 16 | 20 | 100 | 0.5 | 3 | B | B |

The disclosure of Japanese Patent Application No. 2015-061572, filed on Mar. 24, 2015, is incorporated herein by reference in its entirety.

All publications, patent applications, and technical standards mentioned in the present specification are incorporated herein by reference to the same extent as if such individual publication, patent application, or technical standard was specifically and individually indicated to be incorporated by reference.

1. A method of manufacturing a composite film, the method comprising:
a coating liquid preparation step comprising preparing a coating liquid comprising a resin and a filler and having a viscosity of from 0.1 Pa·s to 5.0 Pa·s;
an aggregate removal step comprising removing aggregates contained in the coating liquid by making the coating liquid pass through a filter having a minimum pore diameter that is larger than a maximum particle diameter of the aggregates;
a coating step comprising coating the coating liquid that has been subjected to the aggregate removal on one surface or both surfaces of a porous substrate, to form a coating layer; and
a solidification step comprising solidifying the resin contained in the coating layer, to obtain a composite film comprising: the porous substrate; and a porous layer that is formed on one surface or both surfaces of the porous substrate and that contains the resin and the filler.

2. The method of manufacturing a composite film according to claim 1, wherein the minimum pore diameter of the filter is from 2 times to 10 times the maximum particle diameter of the aggregates.

3. The method of manufacturing a composite film according to claim 1, wherein the maximum particle diameter of the aggregates is from 2 μm to 30 μm.

4. The method of manufacturing a composite film according to claim 1, wherein primary particles of the filler have a volume average particle diameter of from 0.1 μm to 3.0 μm.

5. The method of manufacturing a composite film according to claim 1, wherein the minimum pore diameter of the filter is from 30 μm to 70 μm.

6. The method of manufacturing a composite film according to claim 1, wherein the aggregate removal comprises applying a pressure of from 0.05 MPa to 0.5 MPa to the coating liquid, to make the coating liquid pass through the filter.

7. The method of manufacturing a composite film according to claim 1, wherein, in the aggregate removal, the coating liquid is passed through the filter at a flow rate of 0.5 L/min or more.
